(19) United States
(12) Patent Application Publication
(10) Pub. No.: US 2003/0133606 A1
(43) Pub. Date: Jul. 17, 2003

(54) QUANTIZATION METHOD, AND RECORDING APPARATUS AND STORAGE MEDIUM USING THE SAME

(76) Inventors: KENTARO YANO, YOKOHAMA-SHI (JP); TETSUYA SUWA, YOKOHAMA-SHI (JP)

Correspondence Address: FITZPATRICK CELLA HARPER & SCINTO, 30 ROCKEFELLER PLAZA, NEW YORK, NY, 10112, US

(21) Appl. No.: 09/332,103

(22) Filed: Jun. 14, 1999

(30) Foreign Application Priority Data
Jun. 18, 1998 (JP) 10-171104

(51) Int. Cl. G06K 9/00; G06K 9/38; H04N 1/407

(52) U.S. Cl. 382/162; 382/251; 358/3.26

(57) ABSTRACT

When a recording apparatus can perform three gradations expression for each of a low density dot and a high density dot, and can perform recording in five gradations in total for an input data of one pixel in order to obtain a high quality image with no occurrence of a pseudo-contour by a very small load control in expressing a recording pixel in a plurality of gradations, a low density dot and a high density dot are respectively quantized to three-value data in two quantization processing sections respectively for the high density dot and the low density dot, thereby determining a recording level, while not providing five quantization processing sections for determining whether or not a dot is formed for each of the five gradations in recording.

### BACKGROUND OF THE INVENTION

The present invention relates to a quantization method in which quantization processing is applied to data for first and second recording means which record input image data in a plurality of gradations which belong to each of different gradations in almost the same hue and a recording apparatus and a storage medium using the method.

In recent years, office automation equipment such as a personal computer, a word processor or the like has come into widespread use. As a system for printing out information which is inputted by the equipment, various kinds of recording systems such as an ink-jet system, an eletrophotographic system, a wire-dot system and or like system have been developed. In these recording systems, a binary recording system is now mainstream, in which an image is expressed by whether or not a dot (an image pixel) is recorded on a storage medium such as paper. On the other hand, capabilities of a personal computer and word processor have been increased with the result that a photographic image and a desk top publishing image are ordinarily output. Therefore, realization of a smooth halftone image expression has strongly been desired.

A typical method in which a halftone image is expressed with a binary recording apparatus is disclosed in “A Binary Expression of a High/Low Density Image by the Dither Method” in NIKKEI ELECTRONICS, 1978. 5. 1, pp. 50 to 65. This is an expression method called “the dither method.” The dither method can be classified into two methods: “a systematic dither method” and “a conditional decision method” based on a feature of quantization. The two dither methods will be described below in a simple manner.

In the systematic dither method, a unit matrix is first determined and a gradation expression can be generated by changing the number of pixels which are recorded in the matrix. For example, when a unit matrix of 4×4 is used, gradation with 17 steps can be expressed by controlling pixels to be recorded in the unit matrix in number from 0 dot to 16 dots. The systematic dither method can perform a high speed processing in a simple manner as compared with the conditional decision method but a regenerated image looks like a rough texture and is not suitable for attaining a natural image with photographic gradation.

In recent years, there has been appeared a quantization technique in which, as disclosed in U.S. Pat. No. 5,111,310, a dither matrix with a sufficient scale is used and a pattern showing a spatial frequency characteristic called blue noise is assigned to the matrix. Regeneration of a visually excellent halftone can be attained while the high speed processing characteristic of the conventional dither method is retained since processing in quantization is equal to the conventional dither method (hereinafter referred to as blue noise dither method).

The blue noise dither method is a quantization method whereby a noise sense in an output image is visually suppressed by restricting a power spectrum of a low-frequency component to which the human eye is sensitive.

On the other hand, as the conditional decision method, there has been known the error diffusion (ED) method. The principle of this binary quantization method is disclosed in R. W. Floyd and L. Steinberg, “An Adaptive Algorithm for Spatial Gray Scale” SID 75 Digest (1976). The binary quantization method is a gradation expression method in which differences (error data) between pixel densities of an original image and those of a recording image recorded by a recording apparatus are calculated, peripheral pixels before the quantization are applied with specific weights and the error data, which is a calculation result, are quanterized while the data are dispersed. In other words, this is a system in which quantization errors for pixels are quantized while the errors are propagated to unquantized pixels. Hence, the ED method is complex and not suitable for high speed processing. However, the processing is a method which is most generally used as quantization means which faithfully regenerates a halftone image with photographic gradation since densities of an original image can be preserved or the like.

These dither method and error diffusion method are used not only to quantize a multi-value original pixel to a binary coded data but to quantize a multi-value original pixel to an n-value quantization level (n-value quantization), where n is more than 3.

As an n-value quantization method of the systematic dither method, there is available a density pattern method. In this quantization method, the number of output (recording) pixels is defined according to a level of an input pixel and one pixel is expressed in plurality of gradations in a binary recording apparatus. For example, in the method, when an input pixel is 8 bit data (256 gradations), the input pixel data are quantized into 16 gradations for each of 16 levels and thereby an output pattern is recorded in a one to one correspondence to the input pixel levels. There are available methods for recording in 16 gradations according to a variety of developments: one is to arrange recording dots at different recording positions respectively, another is to superpose recording pixels at the same recording position and still another is to superpose recording pixels only at some recording positions. Furthermore, a plurality of dither matrices are prepared in advance and one input pixel is evaluated in a plurality of times (the number of times corresponding to the number of dither matrices set) and thereby the number of times of recording at the pixel position is determined.

As an example of the n-value quantization in the conditional decision method, there has been known an n-value error diffusion method in which at least 3 thresholds as shown in Japanese Patent Application Laid-Open No. 08-32805 are set and error diffusion processing is performed.

In this way, various methods have been studied and disclosed as quantization methods, in which a multi-value input level is quantized to an output level for a recording apparatus.

On the other hand, there are also available a plurality of systems as a recording apparatus for recording using recording data which are quantized using the various system described above. Recording apparatuses have been developed in which recording dots which can regenerate a plurality of gradations are formed, for example: a high/low density recording system in which a halftone expression is effected by combination of a high density dot obtained by forming a pixel with dark ink and a low density dot obtained by forming a pixel with light ink of a low density in almost the same hue, a large/small dot recording system in which a halftone expression is effected by forming recording pixels through modulation in size of a recording dot and a large/small dot, high/low density system which is combination of both recording systems.

Recording resolution has constantly been improved to a higher degree in order to regenerate halftone expression with high fidelity and thereby progress has been attained in realization of a high quality image by recording pixels.

However, a quantization method and a recording apparatus which have heretofore been used in a conventional way for a high quality image has the following inconvenience.

When the conventional 3-value quantization method is used for quantization in high/low density recording, there are chances when rough texture or a pseudo-contour arises in gradation of an output image. The 3-value quantization method is to quantize one pixel of an input image data into 3-value information comprising 0, 1, 2, wherein 0 corresponds to a pixel which is not printed, 1 corresponds to a pixel which is printed as a dot with light ink and 2 corresponds to a pixel which is printed with dark ink.

Here, a human generally recognizes an image which is subjected to filtering which depends on a spatial frequency characteristic of an object image which is explained as an MTF of the visual system. Accordingly, for example, when an image in gradations ranged from a low level to a high level is recorded using the 3-value error diffusion method, high density dots are printed after all pixels at a gradation level are printed with low density recording dotes in a low density 100% duty cycle. When a recording-apparatus with a resolution of the order of 300 DPI or 600 DPI is assumed to be used, almost all components constituting an image are of DC just before a low density print duty grows to 100% and an image is in a state in which a contrast between dots cannot be recognized. As a result, a very smooth image with less of granularity can be expressed though the recording is a binary-coded one. When an input gradation value is increased and high density dots begin to be mixed into low density dots in order to raise a density further, since high density dots are only very sporadically dispersed in a first period, a spatial frequency shows a low frequency characteristic which is very sensitive to the visual characteristic of a human. That is, an image which has been recognized as visually very smooth is rapidly changed over to an image which is rich in granularity accompanying a rough sense. At this point, even if a density characteristic of an output image is transited so as to be almost equal to a gradation value of an input image, a contour comes to be sensed in an output image by a drastic change in granularity on the image. This is one of major causes for a pseudo-contour which is problematic in a high/low density image.

This phenomenon can be explained based on a way in which a RMS granularity of a recording image which is recorded for each input gradation level is changed. The RMS granularity is a general technique to quantify a granularity sense of an image, buta RMS granularity is drastically changed during transition of gradation with a smooth sense of granularity in the conventional 3-value quantization method. This drastic change in granularity is visually recognized as a pseudo-contour.

In this way, in the case of the high/low density recording, image disorder arises easily compared with the case of the binary recording. For a measure against such an image disorder, if high density recording data and low density recording data are subjected to separate quantization processes (hereinafter referred to as separate plane processing), transiton between high density recording dots and low density recording dots as well as the state of granularity can be controlled and occurrence of such a pseudo-contour which is caused by a recording dot pattern can be suppressed, for example, in the same way as the case where separate quantization processes are respectively applied for generation of quantization recording data in different colors.

However, a high/low density recording apparatus is one which is desired to output a high quality image with photographic gradation. Therefore, the recording apparatus is naturally required to process a plurality of color data different in hues with high recording resolution. A load is too much for the separate plane processing to be properly operated. Especially, when a high density recording dot and a low density recording dot respectively have a plurality of levels, for example respectively two levels, 4 plane processings have to be performed for one color, which problematically makes construction of an appartus very complex.

### SUMMARY OF THE INVENTION

The present invention has been made in order to solve the problem of the prior art and it is accordingly an object of the present invention to provide a quantization method, in which a high quality image can be obtained while occurrence of a pseudo-contour is prevented by a control with a very small load in the case where a recording pixel is expressed in a plurality of gradations by high/low density recording, large/small dot recording or the like, and a recording apparatus and a storage medium using the quantization method.

In order to attain the object, the present invention is directed to a quantization method in which quantization processing is applied to data for first and second recording means which record input image data in a plurality of gradations which belong to each of different gradations in almost the same hue, comprising the steps of:

inputting multi-value level image data;

performing quantization of the image data input for the first recording means to data with a lower level than that of the input image data (hereinafter referred to as first quantization step);

performing quantization of the image data input for the second recording means to data with a lower level than that of the input image data (hereinafter referred to as second quantization step), wherein

at least one of the first and second quantization steps performs quantization of the input image data to multi-value data with 3 or more levels, so that the corresponding one of the first and second recording means may record the image in a plurality of gradations.

The present invention is directed to a recording apparatus which includes first and second recording means which record input image data in a plurality of gradations which belong to each of different gradations in almost the same hue, comprising:

input means for inputting multi-value level image data;

first quantization means for performing quantization of the image data input for the first recording means to a data with a lower level than that of the input image data; and

second quantization means for performing quantization of the image data input for the second recording means to a data with a lower level than that of the input image data, wherein

the first and second recording means record the input image data respectively in first and second gradations according to a quantization result from the first quantization means, at least one of the first and second quantization means performs quantization of the input image data to multi-value data with 3 or more levels and the corresponding one of the first and second recording means record the image in a plurality of gradations.

The present invention is directed to a storage medium from which a computer can read out a control program which is used for performing quantization of data for first and second recording means which record input image data in a plurality of gradations which belong to each of different gradations in almost the same hue, comprising:

a first quantization step module for performing quantization of the image data input for the first recording means to data with a lower level than that of the input image data;

a second quantization step module for performing quantization of the image data input for the second recording means to data with a lower level than that of the input image data; and

an output step module for outputting results from the first and second quantization steps, wherein

one of the first and second quantization step modules perform quantization of the input image data to multi-value data with 3 or more levels so that the corresponding one of the first and second recording means may record the image in a plurality of gradations.

Other features and advantages of the present invention will be apparent from the following description taken in connection with the accompanying drawings.

### BRIEF DESCRIPTION OF THE DRAWINGS

FIG. 1 is a view for illustrating a quantization method in an embodiment according to the present invention;

FIG. 2 is a block diagram showing a relation between a host computer and a recording apparatus;

FIG. 3 is a perspective view showing a mechanism of a main part of the recording apparatus;

FIG. 4 is a block diagram showing construction of the recording apparatus;

FIG. 5 is a view illustrating a flow of image processing;

FIGS. 6A and 6B are graphs showing relations between an input gradation value and a quantization level of each of high/low density planes;

FIG. 7 is a table showing a relation between a quantization level and a print density level;

FIG. 8 is a view showing a line table in diffusion of error generated by quantization;

FIG. 9 is a graph for illustrating a rapid change in granularity at a boundary between light ink and dark ink; and

FIG. 10 is a control flow chart executed in quantization processing in the embodiment.

### DETAILED DESCRIPTION OF THE PREFERRED EMBODIMENTS

Quantization processing in an embodiment is used for a recording apparatus in which a recording in primary color gradations, such as high/low density recording, large/small dot recording and large/small, high/low density recording, or the like is performed using recording pixels in a plurality of gradations. The quantization method uses quantization means for separately performing quantization of input data input for a plurality of recording means which respectively record pixels with different gradation levels, and at least two of the plurality of the recording means have an overlapping recording region in which at least two recording means perform gradation recording in a duplicated manner and have quantization means for performing quantization so that the at least two recording means have a gradation recording region in which at least two recording means raise recording levels, in the overlapping recording region. By performing recording of data which is quantized by the quantization method, each of the recording means can arrange recording pixels in a mutually independent and most suitable manner. For example, regeneration of visually smooth gradation at a boundary between a low density recording area to a high density recording area can be realized.

By using quantization means for performing quantization of data in each of the independent planes to n-value data, quantization being independently performed in each of the independent planes, regeneration of halftone corresponding to record resolution becomes possible by image processing corresponding to lower resolution than the recording resolution. With the quantization processing of the embodiment, image processing means can be provided by which the number of man-days required for all the image processing is greatly decreased.

As mentioned above, by using quantization means to perform quantization independently in each of recording means separately from each other or one another and n-value quantization means in each quantization, there can be realized a quantization method by which a halftone image with a high quality can be regenerated at a high speed in a recording apparatus which can record recording pixels in a plurality of gradations and a recording apparatus using the quantization method.

[First Embodiment]

The first embodiment will be described in a concrete manner with reference to the accompanying drawings.

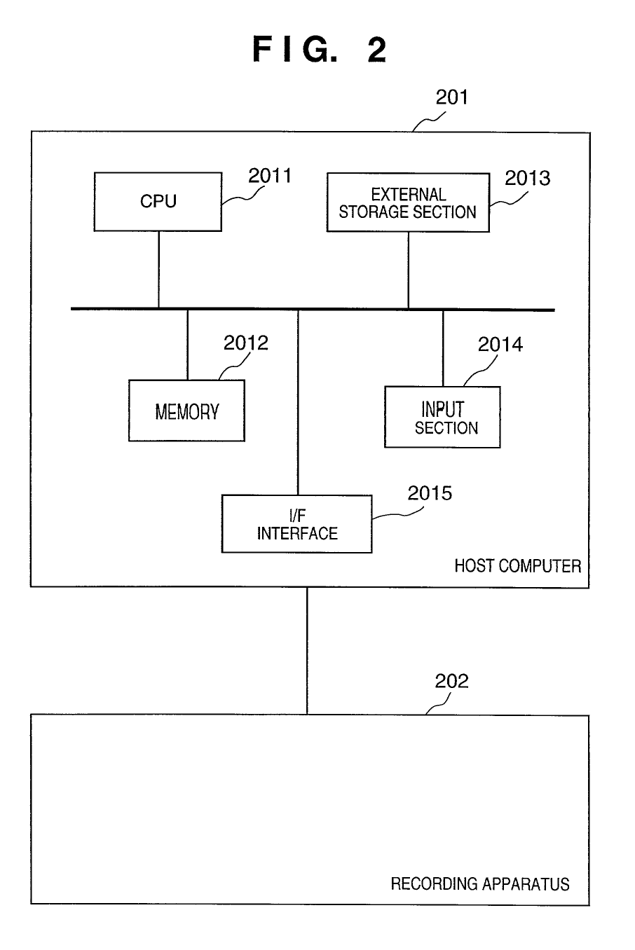

FIG. 2 is a view showing an image processing system to which the embodiment is applied. In the figure, a host computer 201 comprises: a CPU 2011;a memory 2012; an external storage section 2013; an input section 2014; and an interface 2015 with a printer. The CPU 2011 executes a program stored in the memory 2012, thereby realizing procedures of color processing and quantization processing or the like, which will be described later. The programs are stored in the external storage section 2013 or supplied from an external unit. The host computer 201 can execute a procedure of quantization, which will be detailed later, with a hardware built therein specialized for quantization processing. The host computer 201 is connected to a recording apparatus 202 by way of the interface 2015 and transmits an image data which has been subjected to color processing to the recording apparatus 205 to perform print recording.

<Outlines of Recording Apparatus>

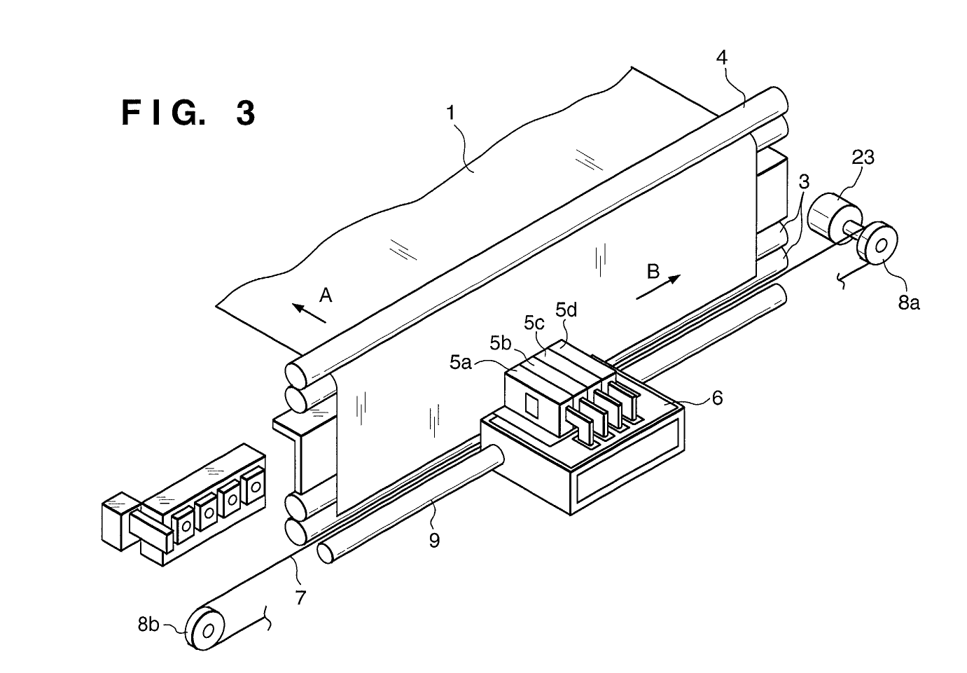

FIG. 3 is an example of the recording apparatus 202 and shows a perspective view illustrating a recording apparatus of an ink-jet type.

First, the overall construction of the recording apparatus will be described. In FIG. 3, 1 indicates a recording sheet made of paper or a plastic sheet. A plurality of recording sheets 1 stacked in a cassette or the like are fed, one at a time, for printing by a paper feed roller (not shown), further transported by a first transport roller pair 3 and a second transport roller pair 4 in a direction of an arrow A, which are disposed mutually spaced at a distance from each other, and which are respectively driven by stepping motors (not shown).

Marks 5a to 5d indicate recording heads of an ink-jet type for performing recording on the recording sheet 1. In the figure, 5a is a recording head for spouting cyan based ink, which can shoot ink dots in dark and light cyan. As in the same way as the cyan based ink, 5b is a recording head for recording a dark magenta dot and a light magenta dot, 5c is a recording head for recording a dark yellow dot and a light yellow dot and 5d is a recording head for recording a dark black dot and a light black dot. In addition, the recording heads 5a to 5d each can perform large/small dot recording with a single nozzle, while selectively forming a large dot or a small dot. The inks are respectively supplied to the recording heads from ink cartridges, not shown, and spouted through the nozzles according to an image signal. There are publicly known techniques, in which one recording head is constructed from a plurality of nozzles and the nozzles are divided into groups, so that different inks are respectively spouted from the groups of nozzles to form recording dots, and in which dots different in volume are spouted from a single nozzle, and detailed description thereon is not given here.

The recording heads 5a to 5d and ink cartridges are mounted on a carriage 6 and the carriage 6 are connected to a carriage motor 23 by way of a belt 7 and pulleys 8a, 8b interposed therebetween. Accordingly, by drive of the carriage motor 23, the carriage 6 reciprocates along a guide shaft 9 for scanning.

With the above described construction, the recording heads 5a to 5d record an ink image by spouting ink on the recording sheet 1 according to an image signal while moving in an arrow B direction. The recording heads 5a to 5d return to a home position when a necessity arises in order to eliminate clogging in a nozzle by an ink recovery unit and at the same time, the recording sheet 1 is advanced by a distance corresponding to one line space in the arrow A direction by drive of the transport roller pair 3, 4. By repeating such a series of actions, predetermined recording is performed on the recording sheet 1.

Then, a control system for driving constituent members of the recording apparatus will be described.

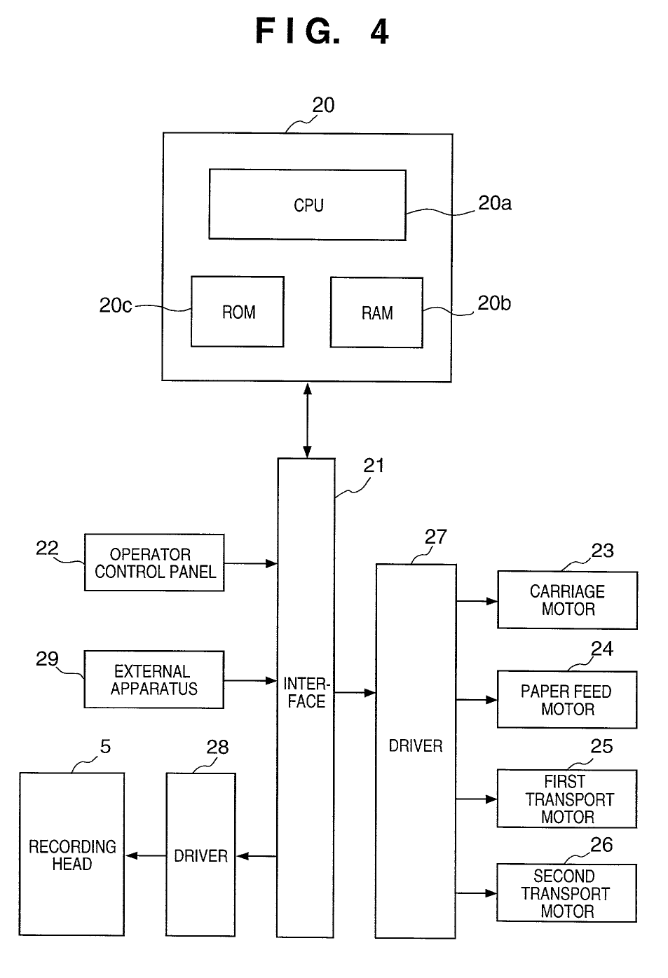

The control system, as shown in FIG. 4, comprises: for example, a control section 20 which is provided with a CPU 20a such as a microprocessor or the like, an ROM 20b in which a control program for the CPU 20a and various kinds of data are stored, and an RAM 20c which is used as not only a work area for the CPU 20a, but for a temporary storage of various kinds of data such as recording image data; an interface 21; an operator control panel 22; a driver 27 for driving various kinds of motors (a carriage drive motor 23, a paper feed roller drive motor 24, a first transport roller pair drive motor 25 and a second transport roller pair drive motor 26); and driver 28 for driving a recording head.

The control section 20 performs I/O (input/output of information) of various kinds of information (for example, a character pitch, a kind of character or the like) from the operator control panel 22 and an image signal to and from an external apparatus 29 by way of the interface 21. The control section 20 further outputs an ON or OFF signal for driving the motors 23 to 26, and an image signal for driving the constituent members.

<Outlines of Image Processing>

Then, there will be described an image processing method which is used when recording data with which recording is performed in the recording apparatus are generated in the host computer.

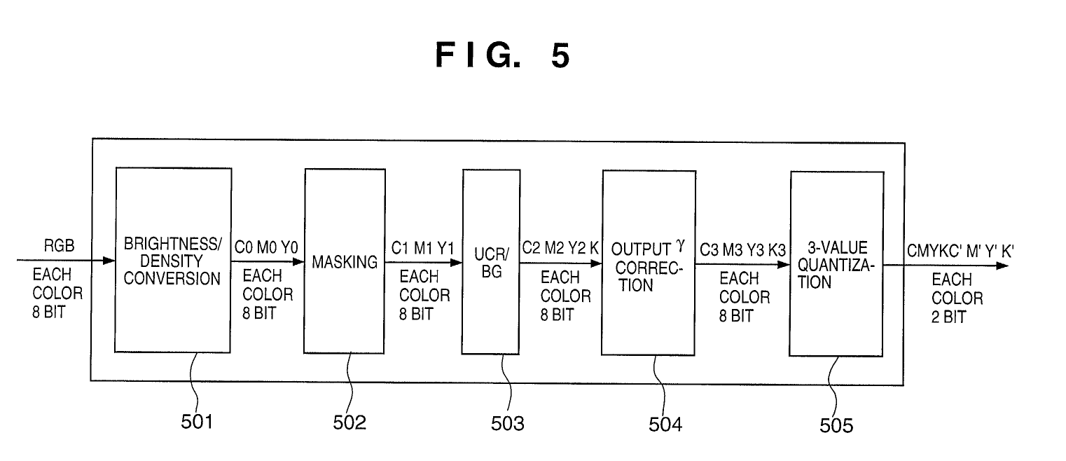

FIG. 5 is an image processing flow in which 8 bit (256 gradations) image data respectively in RGB colors as input are converted to 2 bit information respectively in 8 planes including 2 bit data for dark ink image respectively in CMYK colors and 2 bit data for light ink image in C′M′Y′K′ colors for output.

The processing is performed in the host computer 201.

The 8 bit data respectively in RGB colors are converted to 8 bit data respectively in CMY colors in a brightness/density conversion block 501. In the embodiment, a log conversion described below is performed.

C0=(−255/2.4)*(log 10 [R/255])

M0=(−255/2.4)*(log 10 [G/255])

Y0=(−255/2.4)*(log 10 [B/255])

Then, the 8 bit data respectively in C0, M0 and Y0 are subjected to masking conversion for color space conversion by a masking block. In the embodiment, input CMY data are subjected to matrix transformation in [3×3], thereby outputting 8 bit data respectively in C1, M1 and Y1.

Then, UCR/BG processing for black generation is performed. In the UCR/BG processing, under color removal and black generation are performed and 8 bit data respectively in C1, M1 and Y1 colors are converted to 8 bit data respectively in C2, M2, Y2 and K colors. In a concrete manner, the minimum values uc (uc=min [CMY]) of the recording data respectively in C1, M1 and Y1 are used as under colors and then the C1, M1 and Y1 colors are partly removed by the under colors. The C2, M2, Y2 and K are generated by adding black generation components to the C1, M1, Y1 and K colors according to the minimum values uc which have been removed.

C2=C1−uc+CGR [uc]

M2=M1−uc+MGR [uc]

Y2=Y1−uc+YGR [uc]

K=BGR [uc]

At this point, when CGR [uc], MGR [uc] and YGR [uc] are all nothing for all uc values, black generation is conducted only for a K ink image. When the CGR [uc], MGR [uc] and YGR [uc] have values corresponding to uc, part of black component which has been removed as an under color is expressed as K ink data and the other is expressed as a mixture of color components in C, M and Y (a composite Bk). However, in the embodiment, since light black ink is available, the under color removal and black generation processing is not necessarily required.

Thereafter, output γ correction is performed to complete color processing, thereby generating 8 bit data in C3, M3, Y3 and K3 colors.

Since the color processing completed data have 8 bit gradation levels and are still not converted to output levels for the recording apparatus, quantization processing in which the data are converted to the output levels is conducted. Since all the colors C, M, Y and K can respectively be recorded with a high density dot and a low density dot, the data in CMYK which have been subjected to color processing are to be further respectively applied to quantization processing in at least 2 times for the colors: quantization of the respective colors for high density pixel recording and quantization of the respective colors for low density pixel recording (a quantization method will be detailed later). Besides, in the embodiment, since 3-value quantization for the colors is conducted in the embodiment, the data in CMYK, after the quantization processing is completed, are quantized to 2 bit information of quantized data respectively in C, M, Y and K for high density pixel recording; and 2 bit information of quantized data respectively in C′, M′, Y′ and K′ for low density pixel recording; and then the quantized data are transferred to the recording apparatus, whereby high/low density recording is effected.

<Details of Quantization>

The recording apparatus of the embodiment is a high/low density recording apparatus with a recording resolution of 600 DPI in both directions, longitudinal and lateral, and there arises a need for generating 28,800,000 pixels in recording on an A4 size (8 inches×10 inches) paper in full. Hence, while there arise anxiety about that the number of mandays required for data processing is large and a pseudo-contour at a boundary between high/low density recording occurs, the problems are prevented from occurring by using a quantization method as will be described below.

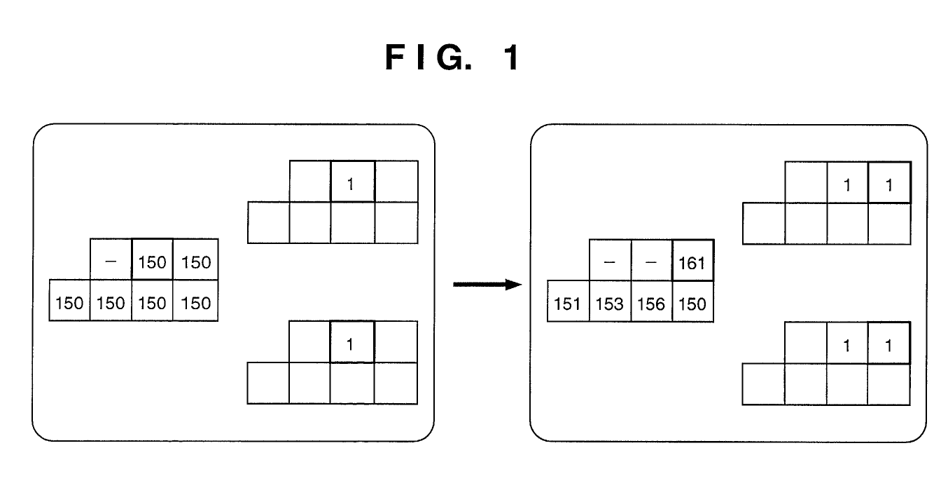

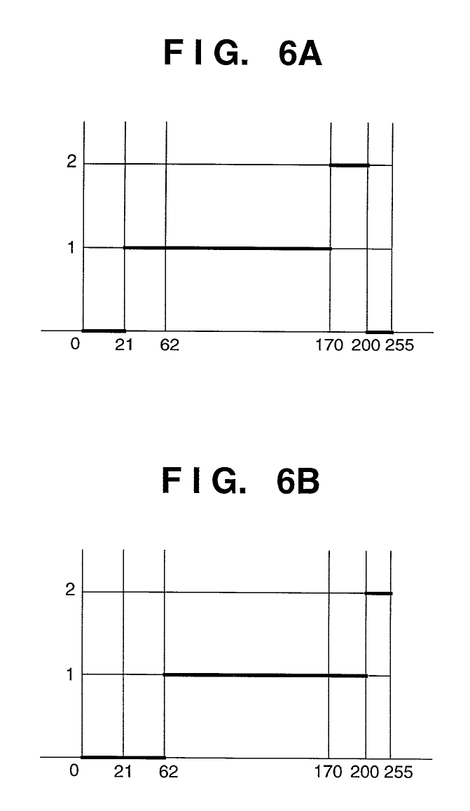

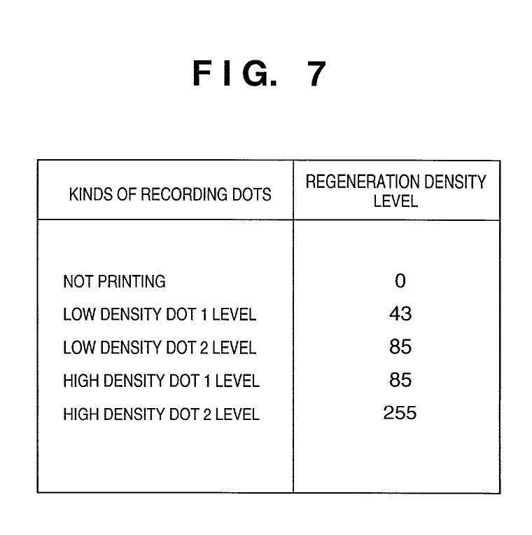

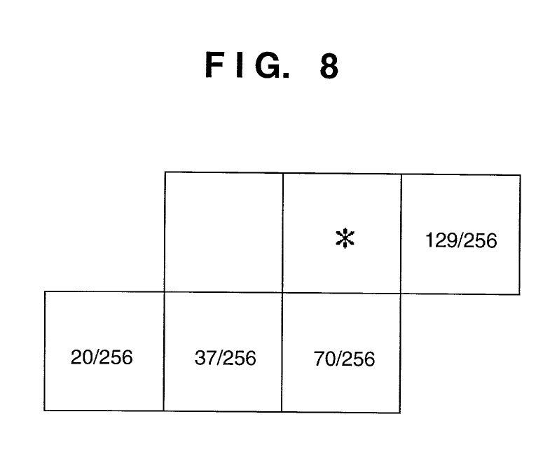

FIG. 1 is a view illustrating a quantization method in which an input of 8 bit data is converted to an output of 5-value data for the recording apparatus. For example, the case of input data at a 150/255 gradation level will be described. The input level 150 is processed in high density recording quantization processing and low density recording quantization processing separately. At this point, correspondence graphs for a gradation level vs. a quantization level are shown in FIGS. 6A and 6B, wherein FIG. 6A is a graph for a quantization level corresponding to low density recording and FIG. 6B is a graph for a quantization level corresponding to high density recording. As is clear from FIGS. 6A and 6B, quantization levels correspond to 3 values for each of the high/low density recording. In the low density recording, an output level 0 is set for an input from 0 to 21, an output level 1 for an input from 22 to 62, an output level 1 for an input from 63 to 170, an output level 2 for an input level from 171 to 200 and an output level 0 for an input level from 201 to 255. In the high density recording, in a similar manner, an output level 0 is set for an input from 0 to 62, an output level 1 for an input from 63 to 170, an output level 1 for an input level 171 to 200 and an output level 2 for an input level from 201 to 255. Recording levels of pixels are shown in FIG. 7. A recording dot of a kind corresponding to a quantization level 1 of a low density dot corresponds to recording to a density level 43, and a recording dot of a kind corresponding to a quantization level 2 of a low density dot corresponds to recording to a density level 85. A quantization level 1 of a high density dot corresponds to a density level 85 and a quantization level 2 of a high density dot corresponds to a density level 255. In FIG. 8, there is shown a relation between peripheral unquantized pixels and their error propagation coefficients produced in quantization. An error generated in a pixel of a quantization object propagates to an unquantized pixel, rightward, adjacent to the object pixel at a propagation ratio 129/256 of the original error and error propagation from the object pixel is further effected to the unquantized pixels underlying the object pixel respectively at propagation ratios of 70/256, 37/256 and 20/256.

Now, description will further be continued returning to FIG. 1. A gradation level of a pixel at a quantization object position in an input image is 150 and the level 150 is compared with quantization levels in density of FIG. 6. That is, output levels of low and high density pixels for input level 150 are respectively determined as 1 and 1. Then, errors of the high/low density pixels are respectively calculated. An output level of the low density pixel is shown as 43 and an output level of the high density pixel is shown as 85 respectively from FIG. 7. That is, since one pixel of a output level 43 and another pixel of an output level 85 are outputted to a position of a pixel with an input level 150, a pixel at a total of 128 level is outputted to the position of the pixel. The shortage, that is an quantization error shows +22 in total. This means that recording with a shortage of 22 gradation levels is resulted at the pixel position. The error +22 propagates according to FIG. 8. An error of +11 levels propagates to a position adjacent to the pixel position of quantization object at a ratio of 129/255 and pixels underlying the pixel of quantization object along the raster scanning course are respectively in a similar manner affected with propagated errors of +6, +3 and +1, which changes input levels 150 of pixels of the original image to 161, 156, 153 and 151.

Multi-value levels of other pixels in the input image are converted to quantized levels which can be outputted for the output apparatus while errors are propagated.

In the quantization method in the embodiment, gradation values from 21 to 62 of 8 bit (0 to 255) of an input are regenerated as recording dots of light ink and gradation values from 201 to 255 are regenerated as recording dots of dark ink. Input gradation values from 62 to 200 are expressed by a mixture of high/low density dots. A region of gradation values from 62 to 169 is one in which recording levels of high/low density dots are both increased.

Then, an effect of smooth transition by the quantization at a boundary between high/low density recording will be described.

In the embodiment, the number of gradations of a dot which can be outputted by a recording apparatus is 5. That is, in the embodiment, 256 gradation values of an 8 bit input pixel are quantized to the 5 gradation information for the recording apparatus.

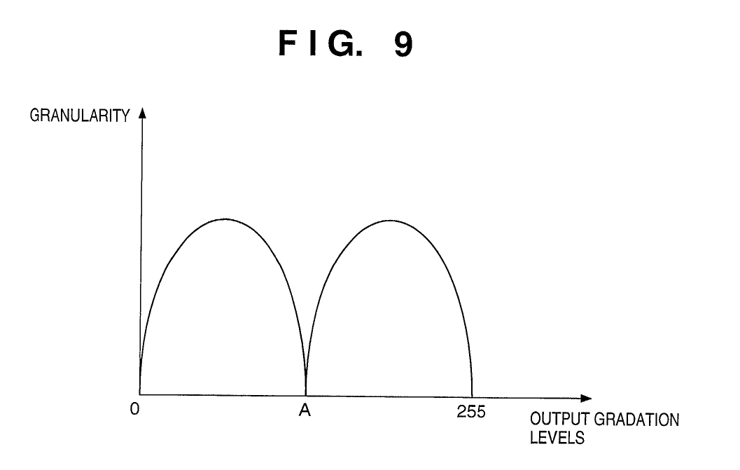

FIG. 9 is a graph illustrating a relation between a gradation value and an RMS granularity when a conventional 5-value ED quantization method is adopted. As can clearly be understood from FIG. 9, a sense of granularity of an image is rapidly changed at a gradation value A on the abscissa which corresponds to a boundary where high/low density dots are interchanged in recording. That is, when gradation values in the vicinity of the A value are regenerated in a conventional way, a change in the appearance of an image occurs in the vicinity of the A gradation value and the change is recognized as a pseudo-contour. Hence, in order to suppress such a image disorder, there arises a necessity that a sense of granularity is guaranteed to be in a smooth way changed over the regenerated region of all gradations. In the embodiment, as mentioned above, in a transition region of gradation, recording generated by low density pixels is overlapped by recording of high density pixels and recording levels of high/low density pixels are both increased in the overlapping region. While a recording density of low density pixels is raised with the result that a sense of granularity caused by low density pixels is rapidly decreased, a sense of granularity caused by participation of high density pixels is increased. Therefore, as a whole, a smooth transition from low density pixel recording to high density pixel recording can be realized with no chance when a rapid change in granularity is resulted. In calculation of the RMS granularity, an aperture diameter of a recording resolution is adopted and in the same way as to attain an RMS granularity for a general purpose, the squares of differences between measurements obtained with the aperture in use and the average density over all the gradations are summed up and then the square root of the sum is calculated, which is the RMS granularity. If a size of the aperture diameter or a color density of each of recording dots of 5 gradations is changed, a shape of a curve in FIG. 9 is relatively changed. However, if recording is performed by a recording apparatus which has regeneration means with dots of a plurality of gradations, while using a multi-value ED quantization method without limiting to a 5-value method, a gradation regeneration region in which a sense of granularity is rapidly changed, theoretically, occurs unavoidably at a juncture between recording means with different gradation dots, such as at a boundary between high/low density dot recording as mentioned above. In the method of the embodiment, since a rapid change in a sense of granularity can be suppressed in a direction for recording means to mutually make up for the change in granularity, such a problem can be restricted.

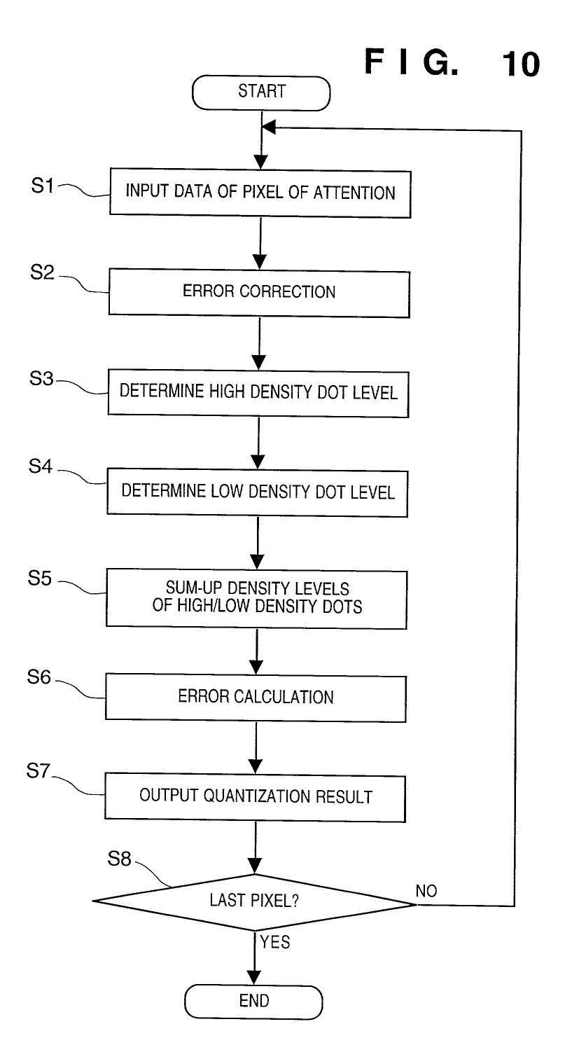

FIG. 10 is a flow chart for illustrating quantization processing in the embodiment and the flow chart is executed in the CPU 2011 of the host computer 201.

In step S1, data of a pixel on which attention is focused (hereinafter referred to as a pixel of attention) are inputted. In step S2, error data produced in quantization processing in the vicinity of the pixel of attention is added to the input data thereof to conduct error correction. Error data produced in quantization processing in the peripheral region of the pixel of attention is stored in the memory 2012.

In step S3, it is discriminated which of quantization levels of FIG. 6A a level of the input data which has been subjected to error correction belongs to and a level of a high density dot is determined.

In step S4, it is discriminated which of levels of FIG. 6B a level of the input data which has been subjected to error correction belongs to and a level of a low density dot is determined.

In step S5, density levels in regeneration (FIG. 7) respectively corresponding to the high density dot level and the low density dot level which have been determined in steps S3, S4 are summed up and a actual density in regeneration of the pixel of attention is attained.

In step S6, a difference between the data which has been subjected to error correction in step S2 and a regeneration density of the pixel of attention which has been calculated in step S5 is obtained and the difference is used as error data. The error data are multiplied by a weight and stored in the memory 2012.

In step S7, a quantization result is outputted to the recording apparatus.

The above mentioned processing is continued till data processing of the last pixel is completed based on judgment of step S8.

While, in the embodiment, each of high/low density dots can respectively be expressed in 3 gradations and all the gradations which can be expressed by dots of high/low densities combined are 5 in number, as compared with the case where five plane processing is effected by corresponding to each 5 gradations, since two plane processing of high/low densities are effected with 3-value quantization processing in each plane as mentioned above, great decrease in mandays for the processing can be realized. While, in the embodiment, realization means for 3 value expression in each plane is realized by selectively providing a large dot or a small dot, a method in which the number of dots in use is controlled may naturally be used as the realization means.

The reason why multi-value quantization processing can be effected in the same plane without suffering image disorder in the embodiment is that the embodiment adopts a method in which a rapid change in RMS granularity does not occur in an image while selectively forming a large dot or a small dot at predetermined points even when multi-value quantization means is adopted.

While, in the embodiment, regeneration of gradations with dots in a plane is realized by selectively forming a large dot or a small dot as mentioned above, a method may be used in which the number of dots formed on an image at a basic resolution is changed, thereby regenerating dot gradations in a plane.

Besides, the embodiment can of course be applied to a system including a recording apparatus with a recording (basic) resolution of 600 DPI in which image processing is conducted at a pixel resolution corresponding to 300 DPI and pseudo-600 DPI recording is performed while each plane is subjected to 5 value-quantization. While, in the embodiment, the example in which high/low density levels are both subjected to 3-value quantization, the present invention can be applied to the case where at least one dot level is subjected to multi-value quantization.

In a recording apparatus which is provided with plural gradation pixel recording means for recording pixels in almost the same hue with plurality of gradations of at least two or more kinds such as dark/light ink recording, multi-sized dot recording or the like, there are provided with: separate plane quantization means for performing quantization in separate plane processing for each of plural gradation pixel recording means; n-value quantization means for further performing at least 3-value quantization of input information corresponding to at least one plane; overlapping recording means in which at least two gradation pixel recording means of the plural gradation pixel recording means perform recording in an overlapping manner when gradations in a primary color are regenerated, thereby performing regeneration of gradations; and a gradation recording region which comprises an overlapping region in which the gradation pixel recording means both raise recording levels, whereby regeneration of smooth gradation can be realized at a high speed without inducing image disorder such as a pseudo-contour while not suffering a large processing load.

[Second Embodiment]

Then, an example in which a systematic dither method is used in a mixed manner will be described as the second embodiment.

While, in the previous embodiment, ED processing of a conditional method is adopted in quantization in both of planes, high and low densities, 2-value processing by a blue noise dither method, which is described in description of the prior art, is used in the second embodiment, for quantization of a low density plane. That is, light ink is subjected only to a recording control in whether or not a dot is formed.

A blue noise dither method used in the second embodiment is a quantization method in which a low spatial frequency component of a recording image is decreased and a high quality halftone image close to an image which is visually subjected to an ED processing can be outputted, as mentioned above. (However, since a matrix generation method or more detailed features of the quantization method are disclosed in U.S. Pat. No. 5,111,310 which is above described and those are publicly known, more detailed description is omitted here.) The dither method is simple in construction compared with the ED method.

Accordingly, by using the blue noise dither method as a quantization method for a plane of a low density recording image, regeneration of a halftone image, which is visually preferable, can be realized without any increase in requirement for mandays in the processing and therefore such a method is suitable for means for regenerating an image with photographic gradation.

In addition, by adapting the systematic dither method to a low density image, a new effect can be expected.

Since the blue noise dither method is a quantization method which uses a mask as described above, a dot print ratio for each gradation can be controlled with ease. For example, when 8 bit gradation processing is performed with a dither mask size of 256×256, each mask is fundamentally assigned with 256 values each from 0 to 255 as evaluation values. This situation is same as in the case of the ED processing; the number of dots assigned to in a fixed area is determined according to a gradation value and, in the ED processing, too, the number of dots to be recorded, for example, in an area of 256×256 is increased by 256 dots on average for each time when a gradation level is raised by one gradation. Needless to say that an output gradation value is not always raised by one gradation according to an output γ correction applied even when an input gradation value is raised by one gradation, but the number of output dots is not changed for increase or decrease in input gradation value of the minimum unit or there is no change in that dots are added for recording according to the number of processing bits.

In a recording apparatus which expresses gradation by areal gradation means in which a recording density is increased or decreased, one of places where a sense of granularity is most explicitly expressed is a place where a gradation value with the minimum unit is expressed, that is a place in the vicinity of a site at which a gradation value of 1/256 is expressed in the embodiment, but in an 8 bit processing, it is required without fail whether no dot is shot in a unit area of 256×256 or 256 dots are shot. If a control is adopted in which dots of a low gradation portion where a sense of granularity is most conspicuously caused are more reduced in number, there arise a need for increase in the number of bits in processing. However, by adopting a blue noise dither method as a quantization method for the low gradation portion in which a sense of granularity is most conspicuous, that is a quantization method for light ink recording, the number of dots to be assigned can be controlled with ease. In the embodiment, a generation frequency of dots in the first 8 gradations, that is a generation frequency of dots each with a gradation value from 1 to 8 is decreased less than a generation frequency which is expected in a normal state, whereby a sense of granularity in a highlight portion is further decreased.

In a concrete manner, when a gradation value is indicated by n and the number of dots printed at a gradation value n is Nn in a 256×256 dither mask with an 8 bit gradation,

0<n≦8→Nn=N(n−1)+256−256/(2*n)

n=9→N9=N8+256

9<n≦246→Nn=N(n−1)+257

246<n≦255→Nn=N(n−1)+258

(, wherein n is a natural number and N0=0.)

That is, in a highlight portion, dots begin to be assigned in a relatively smaller number and a strain caused by the reason that dots in normal number are not assigned is absorbed over all the following gradations other than the first gradations.

Recording dots in most of the cases of a recording apparatus are set to be larger in size than actual recording dots corresponding to a resolution by 10% to 20%. In many cases, dots are set larger in size for a composite reason such as to absorb errors in recording. Accordingly, since an image is regenerated with a higher density than a desired one when recording is conducted with the number of dots proportional to a gradation value, an image density is adjusted with the output γ correction applied.

From the viewpoint mentioned above, there is necessarily no need for recording with the number of dots correctly according to a gradation value, that is such a means is very effective for regenerating a halftone image visually having the highest quality, especially in a highlight portion or the like portion in terms of a comprehensive quality.

While, in the second embodiment, the case where quantization is performed in a 2 value dither method is described, needless to say that multi-value quantization is applicable as in the first embodiment. In this case, thresholds for a plurality of dither matrices are assigned to one input pixel, thereby performing multi-value quantization.

[Other Embodiments]

While, in the above described embodiments, quantization of a low density plane and quantization of a high density plane are both realized by ED (in the first embodiment) and a combination of dither and ED (the second embodiment), the quantization of the low density plane may of course be realized by ED and the quantization of the high density plane may be realized by dither. In the above described embodiments, a sense of granularity of an image at a site where dot recording gets started is attached with much importance and the dither method which has an advantage in way of increase/decrease of dots in number, though there is a case where the method is inferior to ED in terms of spatial frequency, is used for quantization of a plane to express a low gradation portion, but in a system where, for example, light ink which is means for expressing a low gradation portion is sufficiently low in density and rather, a sense of granularity generated by high density dots is required to be attached with much importance, a dither method which has a spatial frequency characteristic represented by blue noise dither is adopted for a high density plane so that an image quality is improved.

While, in the above described embodiments, a plane in which a dark portion gradation is mainly expressed and a plane in which a light portion gradation is mainly expressed are described with limitation to high/low density dot recording, the present invention is not limited to the high/low density recording, but can also be applied to large/small dot recording. In addition, selection of planes is not limited to the case of high/low densities but may be of more sophistication than the segmentation of high/low densities.

According to the embodiments, in such manners, there are provided: a plurality of recording means in which recording pixels of almost the same hue can be recorded; separate plane quantization means for performing quantization processing in separate planes according to a kind of recording pixel (dot) which can be outputted; quantization means for performing n-value quantization of a recording pixel in at least one plane; and quantization means having an expression region of gradation in which recording levels of recording means for mainly recording a highlight portion and recording means for mainly recording a dark portion are both raised when gradation in a primary color in almost the same hue is recorded using a plurality of recording means. Therefore, smooth regeneration of gradation can be realized at a high speed without inducing image disorders such as a pseudo-contour or the like while no large processing load is imposed in a recording apparatus in which recording in a plurality of gradation values such as high/low density recording, large/small dot recording or the like of one pixel can be performed.

In the above described embodiments, when especially one of ink-jet recording systems in which means for generating thermal energy as energy which is used for spouting ink (for example, electrothermal energy converter, laser light or the like) is provided and a change in a state of ink is caused by the thermal energy is used, finer, higher density recording can be achieved.

Typical construction and a principle of such an ink-jet recording system which are disclosed, for example, in U.S. Pat. Nos. 4,723,129 and 4,740,796 specifications as fundamental are preferably adopted. This system can be applied for both of an on-demand type and a continuous type and especially in the case of the on-demand type, at least one drive signal for giving a rapid increase in temperature by which boiling of a film occurs according to recording information is applied to an electrothermal converter which is provided on a sheet or in a liquid pathway on or in which liquid (ink) is held, and with the application of the drive signal, thermal energy is generated by the electrothermal energy converter and film boiling is caused on a thermal action surface of a recording head with the result that a gas bubble is effectively formed in the liquid (ink) which bubble corresponds to the drive signal on a one to one basis. By growth or contraction of a bubble, the liquid (ink) is spouted through a spout opening to form at least one drop. When the drive signal is formed in the shape of a pulse, the growth/contraction of a bubble is properly effected in an instant manner and therefore, especially, spout of liquid (ink) which is excellent in response can be achieved with a preferable result.

As a drive signal in a pulse shape, ones as described in U.S. Pat. Nos. 4,463,359 and 4,345,262 specification are suited. When conditions described in U.S. Pat. No. 4,313,124 specification regarding an invention on a temperature rising rate of the thermal action surface are adopted, more excellent recording can be performed.

The present invention, as structure of a recording head, also includes a structure using U.S. Pat. Nos. 4,558,383 or 4,459,600 specification which discloses a structure in which a thermal action surface is provided in a curved region, in addition to a structure of combination of a spouting opening, a liquid pathway and an electrothermal energy converter, as disclosed in the U.S. Pat. Nos. in the previous two paragraph (a linear liquid pathway or a right-angle liquid pathway). In addition, there may further be adopted a structure based on Japanese Patent Application Laid-Open No. 59-123670 which discloses a structure in which slots in common with a plurality of electrothermal converters are used as spout sections for the electrothermal energy converters and Japanese Patent Application Laid-Open No. 59-138461 which discloses a structure in which an opening which absorbs a pressure wave of thermal energy is designed so as to face a spout section.

Furthermore, as a recording head of a full-line type having a length corresponding to the width of the maximum sized recording medium which can be recorded in a recording apparatus, there may be adopted a structure in which the length is filled with combination of a plurality of recording heads as disclosed in the above mentioned specifications or a structure in which the length is of one recording head which is constructed as a one body.

Still furthermore, there may be adopted not only a recording head of a cartridge type to which an ink tank is mounted in one body which is described in an above described embodiment but a recording head of a tip-type which is freely exchangeable wherein electrical connection with an apparatus body and supply of ink from the apparatus body can be secured by being implemented in the apparatus body.

The above mentioned structures of recording apparatuses are preferably added with a recovery means for a recording heads, preliminary means or the like since recording action can be more stabilized. Additional means will further be detailed below: capping means for a recording head, cleaning means, pressure or suction means, an electrothermal converter, a heating element which is different from the electrothermal energy or preliminary heating means in combination thereof, or the like means. Besides, it is also effective for stable recording that a preliminary spout mode which performs spout separately from recording is provided.

In addition, as a recording mode of a recording apparatus, not only a recording mode using a color in main stream such as black or the like only but a recording mode of at least one of a composite color between different colors and a full color type by mixing colors can be applied to a recording apparatus with a one-body structure of a recording head or a combination of a plurality of recording heads.

While, in the above mentioned embodiments, description is made on the premise that ink is in a liquid state, even ink which is solidified at room temperature or lower, but which is softened or liquefied at room temperature, may be used. Besides, in an ink-jet system, since ink itself is generally controlled at temperature ranging from 30 to 70° C. to adjust a viscosity thereof to fall in a stable spout range, there may be adopted all structures in each of which ink is liquefied at a time when a recording signal is provided.

In order to positively use temperature rise caused by energy for state transition of ink from solid to liquid but to positively prevent evaporation of ink from occurring, ink which is liquefied by heating and solidified when in no heating may be used as well. In any way, the present invention can be applied to the cases of ink of a nature to be liquefied for the first time when thermal energy is conferred, such as the case where ink is liquefied by receiving thermal energy according to a recording signal and thereby liquid ink is spouted, the case where ink begins to be solidified at the time when the ink reaches a recording medium, or the like case. In such cases, ink may face an electrothermal energy converter while the ink is held as liquid or solid in recesses or through-holes on a porous sheet as described in Japanese Patent Application Laid-Open No. 54-56847 or Japanese Patent Application Laid-Open No. 60-71260. In the present invention, the most effective means for the above mentioned various kind of ink is to execute a film boiling method.

Furthermore, as an embodiment of a recording apparatus according to the present invention, in addition to a recording apparatus which is provided in one body or separately as an image output terminal of an information processing equipment such as a computer or the like, there can be named a copy apparatus in combination with a reader or the like together with a form of a facsimile apparatus which has a transmission/reception capability.

The present invention can be applied, for example, to a system configured from a plurality of devices such as a host computer, an interface unit, a reader, a printer or the like, and further can be applied, for example, to standalone equipment such as a copy machine, a facsimile apparatus or the like.

The present invention can be applied in the case where a storage medium in which program codes of software which realize functions of the embodiments mentioned above are recorded is supplied to a system or an apparatus and then the system or the apparatus, that is a computer (CPU or MPU), reads-out the program codes which is stored in the storage medium and executes them.

In this case, the program codes themselves read-out from the storage medium realize functions of the embodiments mentioned above; the storage medium in which the program codes are stored configures an aspect of the present invention.

As a storage medium for supplying program codes, there can be used, for example: a floppy disk, a hard disk, an optical disk, a magneto-optic disk, a CD-ROM, a CD-R, a magnetic tape, a non-volatile memory card, an ROM or the like.

By executing program codes read-out by a computer, not only are functions of the functions of the embodiments mentioned above realized, but an OS (operation system) or the like which is executed by the computer performs part or the whole of actual processing based on instructions of the program codes and by the processing, the embodiments mentioned above are realized. It is needles to say that the cases where the embodiments mentioned above are realized by executing program codes read-out by a computer are included in the scope of the present invention.

Besides, it is needless to say that the present invention also includes in the scope the case where program codes read-out from a storage medium is written into a memory which is provided in a function extension board inserted in a computer or a function extension unit connected to a computer, thereafter, a CPU or the like which is provided to the function extension board or the function extension unit performs part or the whole of actual processing according to instructions of the program codes and by the processing, the functions of the embodiments are realized.

According to the present invention, as mentioned above, when recording pixels are expressed in a plurality of gradations such as high/low density recording, large/small dot recording or the like, a high quality image with no pseudo-contour is achieved by a very small load control.

The present invention is not limited to the above embodiments and various changes and modification can be made within the spirit and scope of the present invention. Therefor, to apprise the public of the scope of the present invention the following claims are made.

What is claimed is:

1. A quantization method in which quantization processing is applied to data for first and second recording means which record input image data in a plurality of gradations which belong to each of different gradations in almost the same hue, comprising the steps of:
inputting multi-value level image data;
performing quantization of the image data input for the first recording means to data with a lower level than that of the input image data (hereinafter referred to as first quantization step); and
performing quantization of the image data input for the second recording means to data with a lower level than that of the input image data (hereinafter referred to as second quantization step), wherein at least one of the first and second quantization steps performs quantization of the input image data to multi-value data with 3 or more levels, so that the corresponding one of the first and second recording means may record the image in a plurality of gradations.

2. A recording apparatus which includes first and second recording means which record input image data in a plurality of gradations which belong to each of different gradations in almost the same hue, comprising:
input means for inputting multi-value level image data;
first quantization means for performing quantization of the image data input for the first recording means to a data with a lower level than that of the input image data; and
second quantization means for performing quantization of the image data input for the second recording means to a data with a lower level than that of the input image data, wherein
the first and second recording means record the input image data respectively in first and second gradations according to a quantization result from the first quantization means, at least one of the first and second quantization means performs quantization of the input image data to multi-value data with 3 or more levels and the corresponding one of the first and second recording means record the image in a plurality of gradations.

3. The recording apparatus according to claim 2, wherein the first and second recording means record the image by an ink-jet system in which recording is effected by attaching an ink drop onto a recording medium.

4. The recording apparatus according to claim 3, wherein the first and second recording means record the image with light ink and black ink.

5. The recording apparatus according to claim 4, wherein a size of the ink drop is controlled when the first and second recording means effect recording in a plurality of gradations.

6. The recording apparatus according to claim 2, wherein not only recording is executed by using both of the first and second recording means according to a level of the input image data, but the first and second recording means share a region in which both means effect recording while both raising recording levels.

7. A storage medium from which a computer can read out a control program which is used for performing quantization of data for first and second recording means which record input image data in a plurality of gradations which belong to each of different gradations in almost the same hue, comprising:
a first quantization step module for performing quantization of the image data input for the first recording means to data with a lower level than that of the input image data;
a second quantization step module for performing quantization of the image data input for the second recording means to data with a lower level than that of the input image data; and
an output step module for outputting results from the first and second quantization steps, wherein one of the first and second quantization step modules perform quantization of the input image data to multi-value data with 3 or more levels so that the corresponding one of the first and second recording means may record the image in a plurality of gradations.
